(19) United States
(12) Patent Application Publication
(10) Pub. No.: US 2023/0359026 A1
(43) Pub. Date: Nov. 9, 2023

(54) Housing for a Manufacturing Machine and/or a Part of a Production Line and System for Open-Loop and/or Closed-Loop Control of a Production Facility

(71) Applicant: Siemens Aktiengesellschaft, München (DE)

(72) Inventors: Rebecca Johnson, München (DE); Vladimir Zahorcak, Borinka (SK)

(73) Assignee: Siemens Aktiengesellschaft, München (DE)

(21) Appl. No.: 18/246,235

(22) PCT Filed: Sep. 16, 2021
(86) PCT No.: PCT/EP2021/075504

§ 371 Date: Mar. 22, 2023

(30) Foreign Application Priority Data
Sep. 28, 2020 (DE) 10 2020 212 162.1

(51) Int. Cl. G05B 19/409; G06F 3/01; G02B 27/01

(52) U.S. Cl. CPC G02B 27/0101; G02B 27/0149; G05B 19/409; G06F 3/011; G05B 2219/32014; G05B 2219/36168

(57) ABSTRACT

Various embodiments of the teachings housing for a manufacturing machine and/or a part of a production line, the housing comprising a transparent element used at least partially as: a projection surface for a head-up display comprising an optics module and an imaging unit in addition to the projection surface, a carrier for a transparent interactive input device including at least one of: a transparent multitouch element, a sensor button, a slider, a wheel, a trackpad, and a touchscreen, and/or a combiner for augmented and/or assisted reality.

### CROSS-REFERENCE TO RELATED APPLICATIONS

This application is a U.S. National Stage Application of International Application No. PCT/EP2021/075504 filed Sep. 16, 2021, which designates the United States of America, and claims priority to DE Application No. 10 2020 212 162.1 filed Sep. 28, 2020, the contents of which are hereby incorporated by reference in their entirety.

### TECHNICAL FIELD

The present disclosure relates to manufacturing production lines. Various embodiments of the teachings herein may include housings for a manufacturing machine and/or a part of a production line, and/or systems for open-loop and closed-loop control of the parts and/or the manufacturing machines of a production line.

### BACKGROUND

In production lines and/or facilities, such as modular production lines, microsystem technology, robotics, generative production facilities, etc., there are housings having monitors, operating elements, and/or processors such as computers for status display and/or for the open-loop/closed-loop control of the part of the production line for the individual manufacturing machines and/or parts of the production line. The housings generally have transparent parts such as windowpanes, through which the manufacturing can be observed - by a worker or user - while he/she can read out the data acquired for this purpose on the monitors.

The respective manufacturing machines may be controlled in an open-loop and closed-loop manner and the properties of the product may be checked in the respective manufacturing step via display and/or operating elements such as monitors, keyboards, etc. In some production steps which require, for example, automated manufacturing, welding, irradiation using lasers, a spraying device, a powder application, a gas discharge, an ultra-clean room atmosphere, or another atmosphere that can be monitored better in small units, manufacturing machines or entire parts of the production line are often housed in these housings and/or so-called showcases. These housings and/or showcases have transparent elements, they thus show at least partially the product during the processing, during the assembly and/or manufacturing, the processing machine, wherein interventions can be performed inside the housings from the outside via monitors and operating elements such as keyboards etc.

The transparent elements of the housings are, for example, windows, covers, roofs, and/or transparent doors. The housings can also be made completely transparent. Display and operating elements, such as monitors, are then attached laterally, for example. This has the disadvantage that, for example, these monitors and/or operating elements generally require space and the transparent elements also partially conceal the housings and thus the view of the production.

### SUMMARY

The teachings of the present disclosure provide display and/or operating elements and a system for open-loop and/or closed-loop control of a production facility integrated in a housing as extensively as possible. For example, some embodiments include a housing for a manufacturing machine and/or a part of a production line having at least one transparent element, wherein the at least one transparent element is used at least partially as a projection surface for a head-up display (HUD), the latter at least also comprising an optics module and an imaging unit in addition to the projection surface, and/or as a carrier for a transparent interactive input device, such as a transparent display of at least one transparent multitouch element, sensor button, slider, wheel, trackpad, and/or touchscreen and/or as a combiner for augmented and/or assisted reality.

In some embodiments, the housing comprises a camera.

In some embodiments, the housing comprises a loudspeaker.

In some embodiments, the housing comprises a microphone.

In some embodiments, the housing comprises a 360° camera.

In some embodiments, the housing comprises a haptic film.

In some embodiments, the housing comprises a laser grid.

In some embodiments, the housing comprises an at least 25% opaque film.

In some embodiments, the housing comprises a processor.

As another example, some embodiments include a system for closed-loop and/or open-loop control of a manufacturing machine and/or a part of a production line, comprising a display and operating unit having an HUD unit, a transparent interactive input device, and/or a combiner, sensors, and a processor, wherein the processor is provided to receive, combine, and process the data of the sensors and from the display of operating element and thus to control in an open-loop and closed-loop manner the manufacturing machine and/or the part of a production line.

In some embodiments, the system comprises a camera, a light barrier, a microphone, and/or loudspeaker.

In some embodiments, the system comprises sensors for detecting the quality of the product to be manufactured.

In some embodiments, the system comprises sensors for authenticating a user.

In some embodiments, the system comprises an AI for creating predictions about the progress of the production of the product to be manufactured.

In some embodiments, the system comprises a sensor system for detecting the status of the manufacturing machine, the part of the production line, and/or a tool.

### DETAILED DESCRIPTION

The teachings of the present disclosure may provide a housing for a manufacturing machine and/or a part of a production line having at least one transparent element, wherein the at least one transparent element is used at least partially as a projection surface for a head-up display (HUD), the latter at least also comprising an optics module and an imaging unit in addition to the projection surface, and/or as a carrier for a transparent interactive input device, such as a transparent display of at least one: transparent multitouch element, sensor button, slider, wheel, trackpad, and/or touchscreen and/or as a combiner for augmented and/or assisted reality.

Some embodiments include a system for closed-loop and/or open-loop control of a manufacturing machine and/or a part of a production line, comprising a display and operating element having an HUD unit, a transparent interactive input device, and/or a combiner, sensors, and a processor, wherein the processor is provided to receive, combine, and process the data of the sensors and from the display and operating element and thus to control in an open-loop and closed-loop manner the manufacturing machine and/or the part of a production line.

In the present disclosure, “manufacturing machine” and/or “part of a production line” denotes a device which processes, finishes, transports, assembles, and/or constructs a product to be manufactured in a housing. The devices can operate in a fully or partially automated manner. For example, this can be a robot.

A “head-up display” (HUD) is a display system, in which the user can maintain his head position or viewing direction because the items of information are projected into his field of view. An HUD can be equipped with 3D and/or augmented reality function. In current computer games, status displays which are not part of the virtual environment but are positioned statistically at the edges of the field of view are generally designated as HUD.

An HUD generally comprises an imaging unit, an optics module, and a projection surface. The imaging unit generates the image. The optics module having collimator and deflection conducts the image onto the projection surface or the combiner.

The teachings herein are explained in more detail hereinafter on the basis of exemplary embodiments:

### Example 1

An exemplary structure of an HUD having projection on at least one transparent windowpane or part of such a windowpane of a housing of a production line comprises
An optics module, for example in the form of a display in the form of a haptic film and/or a laser grade for gesture interaction, and an at least 25% opaque film for the projection on the transparent windowpane, which is a Plexiglas windowpane, for example.
An imaging unit in the form of a close range projector.
A processor which receives, processes, and sends or passes on or returns data of the product to be manufactured, the manufacturing machine, the optics module of the HUD, the sensors, the touch elements, and/or the imaging unit to one of these modules, by which the system controls in an open-loop and closed-loop manner
for example an optical sensor such as a light barrier for the activation of the system when a user is detected,
for example a loudspeaker and microphone for speech interaction and/or alarm output.

The windowpane forms, for example, the projection surface of the HUD. This is in particular a reflective, light-transmissive windowpane. The user of, for example, a windowpane projector thus sees the reflected items of information of the imaging unit and at the same time the real world of the production behind the windowpane.

In some embodiments, the system has various sensors which are interfaces to the user, to the manufacturing machine in the housing, and to the product to be manufactured. These sensors send the data detected thereby to the processor, which processes these data and in turn sends corresponding signals to the manufacturing machine, the imaging unit, the loudspeaker, and/or the touchscreen. All types of known sensors can be used as sensors, analytical sensors for checking the quality of the product to be manufactured, sensors generating light, temperature, pressure, audio and/or video data, for example “sensors” such as camera and/or microphone.

In some embodiments, the system comprises an artificial intelligence (AI), which creates a prediction for the progress of the production of the product to be manufactured with the aid of the data combined and processed by the processor. Error sources in the production can thus be recognized and eliminated rapidly by the detection of the data.

Furthermore, the system can detect the status of the manufacturing machine and/or the tools used via the sensors, wherein the data are again either, for example, displayed by the HUD or processed by an AI and corresponding predictions, requirements, etc. are displayed by the HUD.

“Combiner” refers to a device which combines signals from various sources to form one signal. For example, a combiner for augmented reality combines light which is incident from the surroundings with light which comes from an image source - such as the imaging unit of an HUD - to form a joint view. A possible structure of a combiner comprises semitransparent mirrors, which let through ambient light and at the same time reflect a display installed at the matching distance, for example a liquid crystal display (LCD).

For an observer from a matching perspective, the impression thus results that the graphics displayed on the display are located behind the combiner, while objects located behind the combiner are still visible.

In a housing of a production line having HUD display, the combiner is often simply the Plexiglas windowpane. In some embodiments, there are also so-called “boxed combiners”, which use a separate small windowpane independently of the Plexiglas windowpane to merge the virtual graphics with the light from the physical surroundings.

The generated virtual image can be projected so that it can be acquired with one eye - monocular - or with both eyes - binocular. Binocular HUDs have a higher visibility range than monocular ones. The projection of the virtual image is directed to the size and the distance from the physical object behind the windowpane.

For example, special laser and/or light-emitting diodes are used as the light source for HUDs. The brightness of the image is open-loop controlled in dependence on the ambient light via a photosensor.

An optics module of an HUD and/or a haptic film in the form of a touch element and/or a combiner - thus an interactive display and/or input element - is generated, for example, by a colored high-resolution thin-film transistor (TFT) display. This can be used, for example, in the form of an active matrix display.

Such an interactive display and/or input element is, for example, a device in the form of a transparent touch element. This is available, for example, as a touchscreen or multitouch element in a typical commercial form as flexible transparent films or on glass as the carrier. Touchscreens are also available in the form of transparent multitouch elements, which are operable via sensor buttons, thus electronic switching elements, which are open-loop controlled by means of finger touch without mechanical buttons, and/or by means of zooming and wiping, etc.

Input devices such as displays and/or touchscreens, in which electrical signals are generated by circling, wiping, and/or pulling movement of the hand and/or a finger and/or a pen and thus inputs can be made reliably and unambiguously into a system having processor, are referred to as a “wheel” and/or as a “slider”.

A “processor” is a programmable arithmetic unit, thus a machine, which controls other machines or electrical circuits according to delivered commands and drives an algorithm, which usually includes data processing. A computer comprises a processor, a server comprises a processor, etc.

By way of a transparent display and/or operating element according to another exemplary embodiment of the invention having corresponding sensors it is possible that a user who walks past is informed about the most up-to-date KPIs (key performance indicators) and/or about the current assembly design plans, about the current status of the product, and/or the current documentation of the storage containers, machines, tools, and facilities. For example, the display and/or operating element can be equipped for this purpose with a sensor switch, by way of which the display and/or operating element can assign the user to a group which has certain authorizations, so that the processor, after receiving the signal that the user is in the vicinity, immediately provides the items of information tailored to the respective user via the display.

A display and/or an indicator in which items of digital information are overlaid on the physical world in real time is referred to as “augmented reality (AR)”. That is to say, the users still perceive their environment, but this is supplemented with virtual elements and items of information.

A minimalistic form of “augmented reality” is referred to as “assisted reality”, in which users have, for example, items of text information overlaid, so that course of time, degree of production, product status, test results are visible in the HUD, so that the user sees the product and at the same time perceives the results of the running quality tests, for example surface roughness of a wafer etc., via the projection surface of the HUD on the windowpane.

Simultaneously with the data about the manufacturing product, data about the manufacturing machine, for example the number of the rotations of a robot arm per minute etc., can be overlaid via assisted reality.

A further combination of virtual and physical world is referred to as “mixed reality”. In mixed reality, a digitally generated virtual world is combined with items of information and/or elements of the physical world. The user can act both in the physical and in the virtual world here.

Above all “augmented reality”, thus the overlay of digital contents over the real affected components of the facility and the natural interaction with the system may be implemented by the use proposed here of the transparent elements of housings of the devices and machines of a production line as HUDs or multitouch display and input elements having greatly varying accompanying sensors, and modules for speech interaction. Contents can thus be provided efficiently with context for faster comprehension by users and decisions can be made or tasks can be performed directly in a natural manner by speech interaction, gestures, etc.

For example, the system detects an irregularity on the housed machine and reports this in an automated manner. The user located in the closest proximity authenticates themselves on the system, for example by means of smartphone, card reader, smartwatch, facial recognition, and/or voice, and depending on the role is tasked with eliminating the irregularity - under certain circumstances immediately with action recommendations. Depending on the role, this can extend at least to a simple list of responsible contacts who are to be found immediately, up to a video introduction, which can be played back via the HUD, for immediate error elimination.

In some embodiments, the system recognizes a passing user - this can be a human or machine “AEV” - and outputs a selection of simple tasks with the request to carry them out. For some tasks, expert knowledge is not required, for example refilling packaging cardboard. On the other hand, however, expert knowledge can be required, the task issued by machine to an arbitrary user then involving finding the closest human for the tasks and accompanying them back.

In some embodiments, the system recognizes a passing user by way of a sensor system for authenticating the user. This can comprise, for example, a face recognition, a speech recognition, a Bluetooth recognition, and/or an RFID recognition, etc. The system then addresses the user in an automated manner and gives them their task.

If no current task exists for the affected user or a passing user, the system simply displays the KPIs and the current status with the aid of augmented reality of the facility. Furthermore, AI-assisted predictions are output, such as resources which could be used up in X minutes and a refilling requirement will arise or the point in time of the last maintenance.

In some embodiments, the system identifies a passing user, for example, on the basis of their smartwatch or smartphone. For this user, role-related data and tasks not affecting them are then hidden.

In some embodiments, the system recognizes a passing user and displays the KPIs and/or the current status with the aid of augmented reality of the system on the projection surface of the HUD. Furthermore, AI-assisted predictions, which are created, for example, in an automated manner by the processor on the basis of the data acquired by the sensors, can be displayed. The user can thus recognize immediately that, for example, in X minutes a storage container will be consumed, or a nozzle will be completely clogged and thus there is a need for cleaning or that a screw is coming loose on the machine, etc. The point in time of the last maintenance etc. can also be displayed in an automated manner.

In some embodiments, the system also comprises a camera, for example a 360° camera. The system can thus acquire further data and have it incorporated via the processor, which comprises the open-loop control of the system, in an AI or other data processing.

Three-dimensional video data may also be acquired and likewise processed via one or more cameras. For example, a camera can acquire that a user needs assistance in a specific process step, which is then provided to him in an automated manner via the HUD.

The system can thus display the tasks of a production machine such as those of a user via the HUD and visualize the degree of processing. Furthermore, the work can be displayed prioritized according to degree of urgency or time dependence.

The system can also visualize irregularities in the work sequence via the camera of the system, so that it can establish by comparison by means of AI in the processor poor posture, absence, closed eyes, etc. and communicate or display them in an automated manner. The system can also produce in an automated manner the personal settings of a user by authentication of the user.

The possibility is opened up for the first time by the present invention of replacing conventional monitors in a production line and simultaneously, by using transparent interactive display and input elements such as transparent multitouch elements and/or HUDs, using the transparent areas of the housings of a production line via augmented reality and/or assisted reality.

What is claimed is:

1. A housing for a manufacturing machine and/or a part of a production line, the housing comprising:
a transparent element used at least partially as:
a projection surface for a head-up display comprising an optics module and an imaging unit in addition to the projection surface,
a carrier for a transparent interactive input device including at least one of: a
transparent multitouch element, a
sensor button, a
slider, a
wheel, a
trackpad, and a
touchscreen, and/or
a combiner for augmented and/or assisted reality.

2. The housing as claimed in claim 1, wherein the housing holds a camera.

3. The housing as claimed in claim 1, wherein the housing holds a loudspeaker.

4. The housing as claimed in claim 1, wherein the housing holds a microphone.

5. The housing as claimed in claim 1, wherein the housing holds a 360° camera.

6. The housing as claimed in claim 1, wherein the housing holds a haptic film.

7. The housing as claimed in claim 1, wherein the housing holds a laser grid.

8. The housing as claimed in claim 1, wherein the housing comprises an at least 25% opaque film.

9. The housing as claimed in claim 1, wherein the housing holds a processor.

10. A system for closed-loop and/or open-loop control of a manufacturing machine and/or a part of a production line, the system comprising:
a display and operating unit having an HUD unit;
a transparent interactive input device;
sensors; and
a processor programmed to receive, combine, and process the data of the sensors and to operate the display of operating element and to control in an open-loop and closed-loop manner the manufacturing machine and/or the part of a production line.

11. The system as claimed in claim 10, further comprising: a camera, a light barrier, a microphone, and/or a loudspeaker.

12. The system as claimed in claim 10, wherein the sensors detect aquality of the product to be manufactured.

13. The system as claimed in claim 10, wherein the sensors operate to authenticate a user.

14. The system as claimed in claim 10, further comprising an AI for creating predictions about the progress of the production of the product to be manufactured.

15. The system as claimed in claim 10, wherein the sensors detect a status of the manufacturing machine, the part of the production line, and/or a tool.
